(19) United States
(12) Patent Application Publication
(10) Pub. No.: US 2010/0284692 A1
(43) Pub. Date: Nov. 11, 2010

(54) ULTRA LOW LATENCY SECURITIES TRADING INFRASTRUCTURE

(76) Inventors: Thaddeus SZELL, Haslemere (GB); Steven COOK, South Benfleet (GB)

Correspondence Address: MORRISON & FOERSTER LLP, 755 PAGE MILL RD, PALO ALTO, CA, 94304-1018, US

(21) Appl. No.: 12/757,759

(22) Filed: Apr. 9, 2010

(30) Foreign Application Priority Data
Apr. 9, 2009 (GB) GB0906290.2
Nov. 18, 2009 (GB) GB0920218.5

(51) Int. Cl. H04J 14/00

(52) U.S. Cl. 398/58

(57) ABSTRACT

A system communicates data in a networked environment via a transaction engine connected to a first local network, a transaction client connected to a second local network, and an optical data link connecting the first local network to the second local network. The optical data link comprises optical fiber which is dark fiber and the transaction client is configured to transmit transaction data to the transaction engine which is configured to carry out a transaction based on the transaction data.

### CROSS-REFERENCE TO RELATED APPLICATIONS

This application claims priority to Great Britian Application Serial No. GB0920218.5, filed Nov. 18, 2009, entitled ULTRA LOW LATENCY SECURITIES TRADING INFRASTRUCTURE, to Thaddeus SZELL et al.; and Great Britian Application Serial No.: GB0906290.2, filed Apr. 9, 2009, entitled ULTRA LOW LATENCY SECURITIES TRADING INFRASTRUCTURE to Taddeus SZELL et al. both of which are hereby incorporated by reference in their entirety for all purposes.

### BACKGROUND OF THE INVENTION

The present invention relates to a system for communicating data in a networked environment, a method of networking and a communications network, for example in a securities trading environment.

It has become common to transmit data between separate, self-contained networks using conventional, pre-existing data links, such as dedicated or leased lines, or across shared resources, such as the Internet.

It has also become common to carry out transactions between parties, for example involving the sale/purchase of goods, assets, financial instruments or securities, by transmitting transaction data between a transaction client and a transaction engine which are located on different local networks. Often, the transactions are time critical and it is therefore desirable to reduce the latency for communicating the transaction data between the transaction client and transaction engine.

In a first aspect of the invention, there is provided a system for communicating data in a networked environment, comprising:

a transaction engine connected to a first local network;

a transaction client connected to a second local network; and

an optical data link connecting the first local network to the second local network,

wherein the optical data link comprises optical fiber which is dark fiber and the transaction client is configured to transmit transaction data to the transaction engine which is configured to carry out a transaction based on the transaction data.

The transaction engine may be a matching engine which matches buyers and sellers of assets in a trade of one or more assets. The matching engine is a highly reliable computer server which is connected to the first local network. The transaction engine connected to the first local network may itself include a transaction client and the transaction client connected to the second local network may itself include a transaction engine. Thus, the transaction client and transaction engine can perform similar functions to each other and operate interchangeably on their individual networks. The first and second networks may be located at different geographical sites, some distance from each other, e.g. in the range of 1 km to 2000 km, or in the range of 10 km to 2000 km, 10 km to 1000 km, or 50 km to 1000 km.

Dark fiber is an individual or pair of optical fiber(s), or plurality of optical fibers, that is lit and used solely by a particular communications device/entity. Dark fiber is/are used solely for communication between the first local network and the second local network. The dark fiber is dedicated for the sole use of an individual, user or company which leases or buys the fiber from a telecommunications company and provides a direct optical link between nodes, ports or networks. This differs substantially from conventional data links which share a resource with other users through multiplexing at a higher layer in the network protocol. As a result, the use of dark fiber in the present invention provides significantly reduced latency for data communicated between local networks in time critical transactions. The system of the invention may advantageously comprise only dark fiber (or substantially only; that is to say dark fiber is used for 60%, 70%, 80%, 90% or 95%, and greater of the total transactions communicated between two networks). Moreover, the optical data link may comprise backbone equipment which consists only of optical backbone equipment. As a result, there is a constant end-to-end bandwidth between the networks, which reduces effects of serialisation induced latency.

In one embodiment of the invention, the system comprises a plurality of local networks including the first local network and the second local network,

wherein each local network comprises at least one of a matching engine or a transaction client,

wherein the optical data link comprises a plurality of core nodes connected together by core links in a ring,

wherein each local network is connected to at least one core node by a network link.

Preferably, each core node comprises an optical switching (or routing) device which connects each core link at the each core node to each network link at the each core node. Each core link may be a core link and/or each network link may be a network link. When the core links are connected together in a ring, the optical switching device routes data to the destination core via the shortest available path, taking into account any faults or cuts in the ring.

Each local network may be connected to at least two core nodes and to each core node by a network link. Alternatively, each local network is connected to every core node and to each core node by a network link.

Each core link may consist only of dark fiber and each network link may consist only of dark fiber.

The length of each core link may be in the range of 1 to 2000 km, or in the range of 10 km to 2000 km, 10 km to 1000 km, or 50 km to 1000 km. The length of each network link may be in the range of 1 m to 100 km or in the range of 1 m to 10 km.

In a second aspect of the invention, there is provided a method of networking a data communication environment, comprising:

connecting an optical data link between a first local network and a second local network,

wherein the first local network comprises a matching engine and the second local network comprises a transaction client,

wherein the optical data link comprises optical fiber which is dark fiber and the transaction client is configured to transmit transaction data to the matching engine which is configured to carry out a transaction based on the transaction data.

In a third aspect of the invention, there is provided a communications network, comprising:

a first local network;

a second local network;

a matching engine connected to the first local network;

a transaction client connected to the second local network; and

an optical data link connecting the first local network to the second local network,

wherein the optical data link comprises optical fiber which is dark fiber and the transaction client is configured to transmit transaction data to the matching engine which is configured to carry out a transaction based on the transaction data.

### BRIEF DESCRIPTION OF THE DRAWINGS

The present invention will now be described by way of example with reference to the accompanying drawings, in which:

FIG. 1 is a schematic of interconnected components of the system of the invention;

FIG. 2 is a further schematic of interconnected components of the system of FIG. 1; and

FIG. 3 is a further schematic of interconnected components of the system of FIG. 1.

### DETAILED DESCRIPTION OF THE INVENTION

The present invention is described below with reference to a particular embodiment, in which it is used for the exchange of financial instruments and securities in a securities trading environment. It will be appreciated that the invention is not limited solely to its described use in financial trading systems and has wider applicability, for example in any transaction processing system in which transactions are transacted across multiple networks and/or sites. The skilled person will realise that the invention concerns a general technical implementation of hardware and infrastructure.

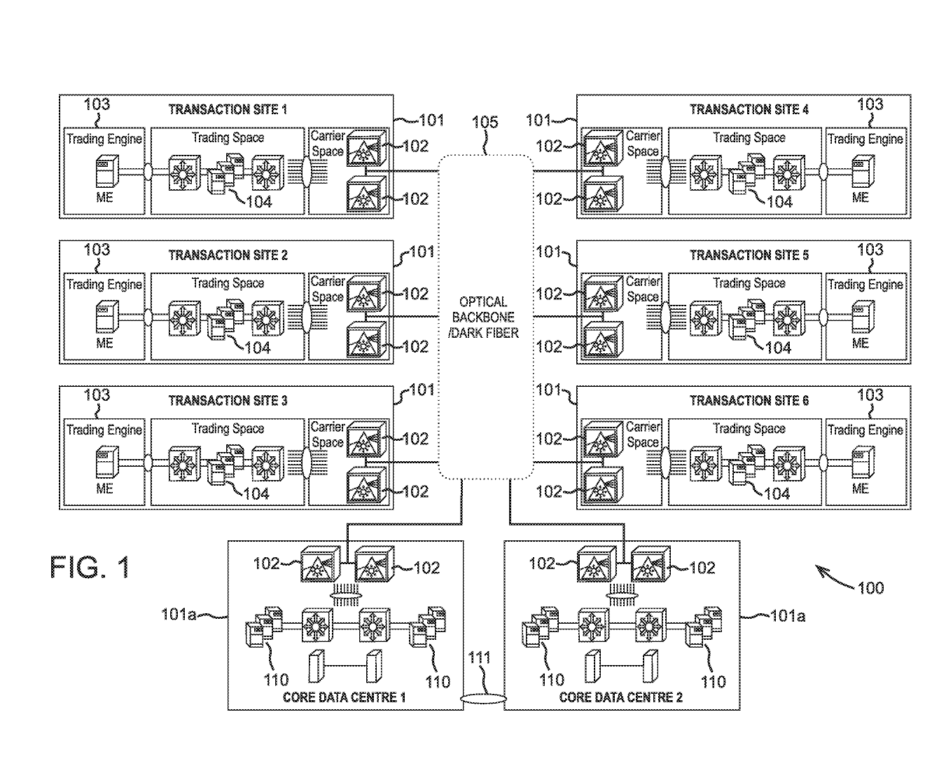

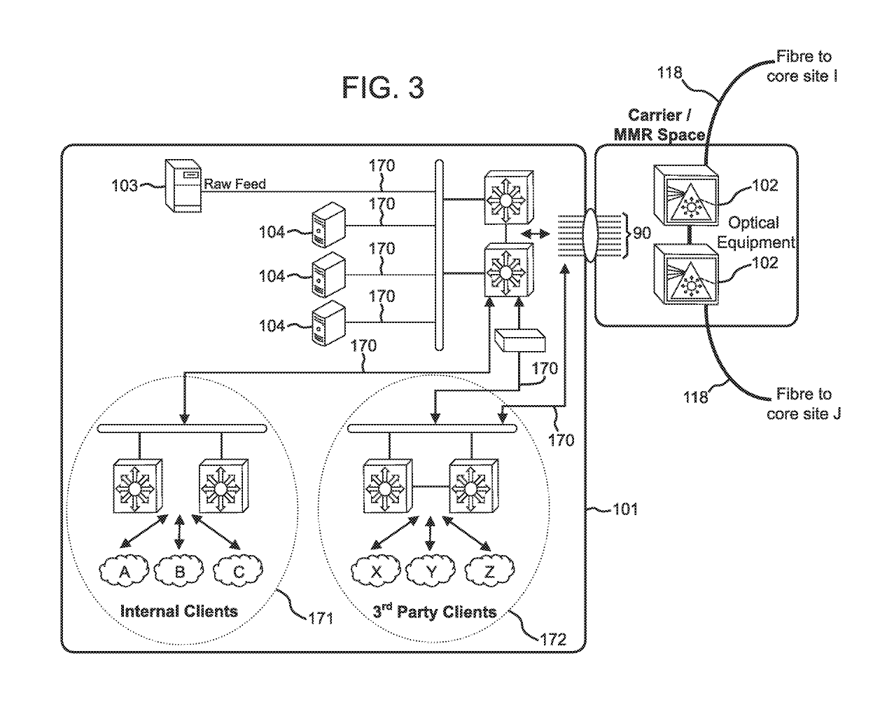

A communications system 100 of the present invention is depicted in FIG. 1. The system 100 comprises multiple local networks, with each local network 101 connected via optical-only switch 102 into a low-latency, optical-only backbone 105. The optical-only backbone 105 is defined as communications infrastructure which has the function of moving data on the optical (photonic) layer. Each local network 101 comprises wired, wireless or optically interconnected components on its network, in particular a transaction engine 103 and data processing devices 104, which are connected across the local network 101 to the switch 102. Client devices (not shown in FIG. 1; see FIG. 3 below) can connect to the local network 101.

The low-latency, optical-only backbone 105 comprises only dark fiber; that is an individual or pair of optical fiber(s), or plurality of optical fibers, that is/are used solely for communication between the local networks. The dark fiber is dedicated for the sole use of the communications system 100, whose operator has been able to lease or buy the fiber from a telecommunications company. The dark fiber and optical equipment on the backbone 105 provides a dedicated, direct optical link between the networks.

In the exemplary embodiment of FIG. 1, two of the local networks provide interconnected components only for data storage and retrieval. Each of these two local networks is a data centre network 101a and contains servers 110 connected to the switch 102 for storing data received across the backbone 105 from any of the other local networks, as requested, retrieving and transmitting data from the servers 110 to the other local networks and for providing data archiving, storage and development services. The two data centre networks may be further interconnected to each other by a wired, dark fiber, optical or Ethernet link to other clients or processing devices.

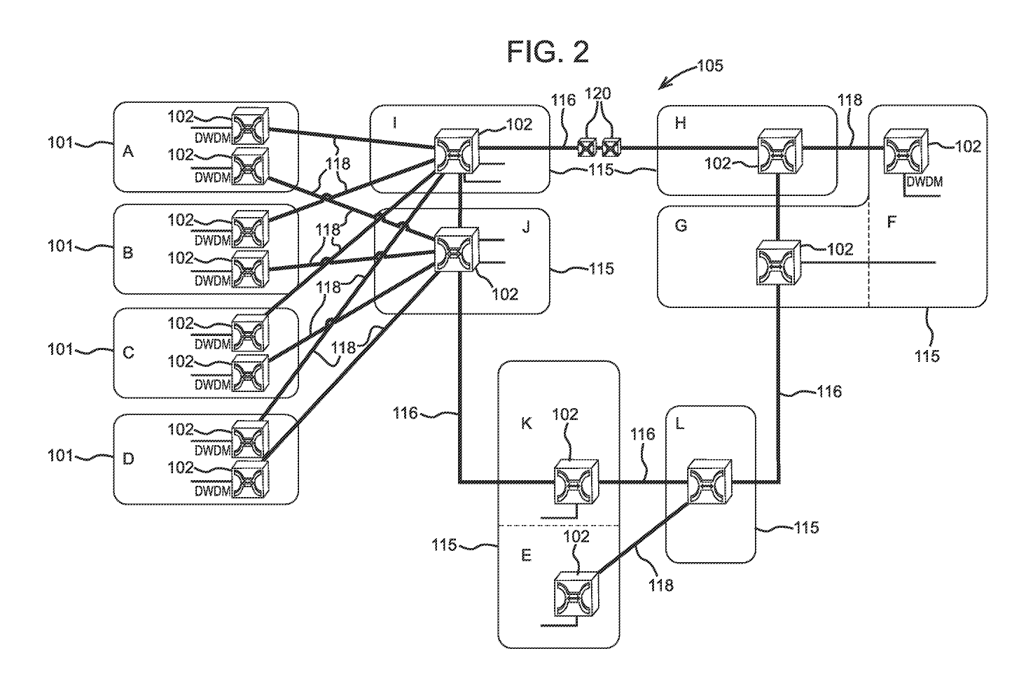

FIG. 2 shows an exemplary embodiment of the interconnections between the local networks across the backbone 105. The backbone 105 comprises network links. Each network link 118 consists of only (or substantially only) direct dark fiber connections between the switch 102 in each of local networks and the switches in core nodes. Each core node 115 comprises an optical-only core node 102. The switches of each core node 102 are connected to the switch in each of two other core nodes via a core link 116 consisting of a direct dark fiber connection. In this way, the core nodes are connected in a ring so that the pair of core nodes connected to a given core node 115 are a different pair for each given core node 115. The function of the core switch 102 is to route data in the most direct (i.e. shortest) path between any two local networks to minimise the communication latency and optical to electrical conversion. Also, with the core nodes connected in a ring, any fault in a particular core link 116 can be avoided by routing data in the opposite direction around the ring.

In the embodiment of the invention depicted in FIG. 2, at least some of the local networks (those labelled: A, B, C and D) are each connected via at least two network links 118 to two different core nodes. This ensures that there is redundancy and backup in the system 100, for example in the case of a fault with a particular network link 118 and/or core node 101.

In the particular embodiment depicted in FIG. 2, one of the core links 116 comprises optical regenerators 120 which receive and retransmit the optical signal (entirely in the optical domain). This is important in dark fiber optical links where it is desirable to minimise signal latency, even in links that traverse long distances.

FIG. 3 shows in greater detail the components of a local network 101. Each local network 101 comprises wired, optical or wireless internal links 170, which may exist between the transaction engine 103, data processing devices 104, internal client devices 171, external client devices 172 and optical switches 102 and which connect via optical-only connections to the network links 118, and, from there, to the core nodes.

The transaction engine 103 also functions as a transaction client to execute transactions with another transaction engine on a different local network. The client devices 171, 172 are operated by a user to transmit and receive instructions for transactions to be carried out via the transaction engine 103 in conjunction with data communicated to/from the data processing devices 104. For example, a client device 171 on one local network may transmit an electronic instruction to the transaction engine 103 for a particular asset to sold at a particular value identified by its corresponding transaction engine 103. A client device 171 on a different local network may transmit an electronic instruction to its corresponding transaction engine 103 (acting as a transaction client) for the same asset to be purchased or sold. The two transaction engines 103 then communicate the request and offer instructions between each other across the backbone 105. If agreed, the asset is agreed to be “sold” by an electronic transfer performed by the seller's transaction engine 102.

The presence of dark fiber on the backbone 105 for carrying the transaction data thereby minimises the transaction latency between the request input to a particular client device 171 and the transaction actually being executed in a particular transaction engine 103 located on a different local network. Hence, deterministic latency can be achieved and established with certainty.

It will of course be understood that the present invention has been described above purely by way of example and modifications of detail can be made within the scope of the invention.

What is claimed as new and desired to be protected by Letters Patent of the United States is:

1. A system for communicating data in a networked environment, comprising:
a transaction engine connected to a first local network;
a transaction client connected to a second local network; and
an optical data link connecting the first local network to the second local network,
wherein the optical data link comprises optical fiber which is dark fiber and the transaction client is configured to transmit transaction data to the transaction engine which is configured to carry out a transaction based on the transaction data.

2. The system of claim 1, wherein the optical fiber consists only of dark fiber or substantially only dark fiber.

3. The system of claim 2, wherein the optical data link comprises backbone equipment which consists only of optical backbone equipment.

4. The system of claim 1, comprising a plurality of local networks including the first local network and the second local network,
wherein each local network comprises at least one of a transaction engine or a transaction client,
wherein the optical data link comprises a plurality of core nodes connected together by core links in a ring,
wherein each local network is connected to at least one core node by a network link.

5. The system of claim 4, wherein each core node comprises an optical routing device which connects each core link at the each core node to each network link at the each core node.

6. The system of claim 4, wherein each local network is connected to at least two core nodes and to each core node by a network link.

7. The system of claim 4, wherein each local network is connected to every core node and to each core node by a network link.

8. The system of claim 4, wherein each core link consists only of dark fiber.

9. The system of claim 8, wherein each network link consists only of dark fiber.

10. The system of claim 4, wherein the length of each core link is in the range of 10 to 2000 km.

11. The system of claim 4, wherein the length of each core link is in the range of 50 to 1000 km.

12. The system of claim 4, wherein the length of each network link is in the range of 1 to 100 km.

13. The system of claim 4, wherein the length of each network link is in the range of 1 to 10 km.

14. The system of claim 1, wherein the transaction engine is a matching engine.

15. The system of claim 1, wherein the transaction engine on the first local network is integrated with a transaction client for the first local network in an integrated device, and/or the transaction client on the second local network is integrated with a transaction engine for the second local network in an integrated device.

16. A method of networking a data communication environment, comprising:
connecting an optical data link between a first local network and a second local network,
wherein the first local network comprises a transaction engine and the second local network comprises a transaction client,
wherein the optical data link comprises optical fiber which is dark fiber and the transaction client is configured to transmit transaction data to the transaction engine which is configured to carry out a transaction based on the transaction data.

17. The method of claim 16, wherein the optical fiber consists only of dark fiber.

18. The method of claim 17, wherein the optical data link comprises backbone equipment which consists only of optical backbone equipment.

19. The method of claim 16, further comprising interconnecting a plurality of local networks including the first local network and the second local network,
wherein each local network comprises at least one of a transaction engine or a transaction client,
wherein the optical data link comprises a plurality of core nodes which are connected together by core links in a ring,
wherein each local network is connected to at least one core node by a network link.

20. The method of claim 19, wherein each core node comprising providing an optical routing device to connect each core link at the each core node to each network link at the each core node.

21. A communications network, comprising:
a first local network;
a second local network;
a transaction engine connected to the first local network;
a transaction client connected to the second local network; and
an optical data link connecting the first local network to the second local network,
wherein the optical data link comprises optical fiber which is dark fiber and the transaction client is configured to transmit transaction data to the transaction engine which is configured to carry out a transaction based on the transaction data.
